(19) United States
(12) Patent Application Publication
(10) Pub. No.: US 2012/0310789 A1
(43) Pub. Date: Dec. 6, 2012

(54) ELECTRONIC COMMERCE SYSTEM, ELECTRONIC COMMERCE METHOD, AND ELECTRONIC COMMERCE PROGRAM

(75) Inventors: Kenji Hayatsu, Shinagawa-ku (JP); Shiwe Zhu, Shinagawa-ku (JP); Tatsuya Yoshinari, Shinagawa-ku (JP)

(73) Assignee: RAKUTEN, INC., Shinagawa-ku, Tokyo (JP)

(21) Appl. No.: 13/578,768

(22) PCT Filed: Feb. 24, 2011
(86) PCT No.: PCT/JP2011/054156

§ 371 Date: Aug. 13, 2012

(30) Foreign Application Priority Data
Feb. 25, 2010 (JP) 2010-040736

(51) Int. Cl. G06Q 30/00

(52) U.S. Cl. 705/27.1

(57) ABSTRACT

To easily set an appropriate supply method for each item, an electronic commerce system (1) includes a list database (13) that stores a supply method list (referred to hereinafter as “list”) containing one or more supply method information about an item available in a virtual shop, a screen providing unit (16) that provides an input screen to associate item information with the list to a virtual shop terminal Ts, a registration unit (17) that stores correspondence information indicating a correspondence between the item information and the list input in the virtual shop terminal Ts into an item supply method database (15), and an item information extraction unit (18) that, when a specific item is selected in a user terminal Tu, reads the list corresponding to the item from the item supply method database (15) and transmits the supply method information contained in the list to the user terminal Tu.

### TECHNICAL FIELD

The present invention relates to an electronic commerce system, an electronic commerce method and an electronic commerce program that manage data handled by a virtual shop.

### BACKGROUND ART

Various virtual shop (electronic shop) systems have been known. In general, a purchaser who accesses a virtual shop selects an item, then selects a payment method and delivery method, and completes the operation to purchase an item. An electronic commerce system that makes the operation easy is disclosed in PTL 1. The system allows an item payment method and delivery method to be set for each user to thereby facilitate the operation for a user to purchase items from a plurality of shops, for example.

### CITATION LIST

### Patent Literature

PTL 1: JP 2005-43975 A

### SUMMARY OF INVENTION

### Technical Problem

However, in the hitherto known systems as disclosed in the above PTL 1, there is a possibility that an unfavorable combination of an item, payment method and delivery method is set by a user. For example, normal temperature delivery can be selected for an item that should be kept frozen, or so-called convenience store payment can be selected for an item that cannot be received at a convenience store. To avoid this, a payment method and delivery method need to be set for each item, which causes a heavy load for data maintenance.

In view of the above, an object of the present invention is to provide an electronic commerce system, an electronic commerce method and an electronic commerce program that can easily set an appropriate supply method for each item.

### Solution to Problem

An electronic commerce system according to the present invention includes a list database for storing a supply method list containing one or more supply method information indicating a supply method of an item available in a virtual shop, a screen providing means for providing an input screen to associate item information identifying the item and the supply method list read from the list database to a specified terminal, a storing means for storing correspondence information indicating a correspondence between the item information and the supply method list input through the input screen in the specified terminal into an item supply method database, and an extraction means for, when a specific item of the virtual shop is selected in a user terminal accessing the virtual shop, reading the supply method list corresponding to the item from the item supply method database and transmitting the supply method information contained in the supply method list to the user terminal.

An electronic commerce method according to the present invention is an electronic commerce method executed by an electronic commerce system and including a screen providing step of providing an input screen to associate item information identifying an item available in a virtual shop and a supply method list containing one or more supply method information indicating a supply method of the item to a specified terminal, a storing step of storing correspondence information indicating a correspondence between the item information and the supply method list input through the input screen in the specified terminal into an item supply method database, and an extraction step of, when a specific item of the virtual shop is selected in a user terminal accessing the virtual shop, reading the supply method list corresponding to the item from the item supply method database and transmitting the supply method information contained in the supply method list to the user terminal.

An electronic commerce program according to the present invention causes a computer to implement a function of a list database that stores a supply method list containing one or more supply method information indicating a supply method of an item available in a virtual shop, a screen providing function that provides an input screen to associate item information identifying the item and the supply method list read from the list database to a specified terminal, a storing function that stores correspondence information indicating a correspondence between the item information and the supply method list input through the input screen in the specified terminal into an item supply method database, and an extraction function that, when a specific item of the virtual shop is selected in a user terminal accessing the virtual shop, reads the supply method list corresponding to the item from the item supply method database and transmits the supply method information contained in the supply method list to the user terminal.

According to the invention, because one or more supply methods can be associated in advance with each item, an appropriate supply method in accordance with the characteristics of the item can be presented to a viewer of the item. Further, because the item and the supply method are associated through the supply method list, the supply method can be changed at a time for a plurality of items simply by editing the contents of the list. It is thereby possible to easily set an appropriate supply method for each item.

The virtual shop is a member shop being a member of a virtual shopping mall containing a plurality of virtual shops, and the storing means may store the correspondence information in association with member shop information identifying the member shop into the item supply method database, and when the specific item is selected in the user terminal accessing the virtual shop, the extraction means may read the supply method list corresponding to the virtual shop and also corresponding to the specific item from the item supply method database.

Because the storing means stores the correspondence information in association with the member shop information into the item supply method database, even if the virtual shop is a member of a virtual shopping mall containing a plurality of member shops, it is possible to present the supply method list that matches the item for each virtual shop. Thus, even when there are a plurality of virtual shops, an appropriate supply method in accordance with the characteristics of the item can be presented to a viewer of the item.

The electronic commerce system according to the present invention may further include a supply method database that stores the supply method information, and the screen providing means may further provide another input screen to create the supply method list containing one or more supply method information read from the supply method database to the specified terminal, and the storing means may further store the supply method list input through the another input screen in association with the member shop information into the list database.

In this case, the supply method information to be contained in the supply method list can be set, and the setting is stored into the list database. Therefore, the setting can be reflected at a time on a plurality of items.

In the electronic commerce system according to the present invention, the supply method information may contain payment method information indicating a payment method of the item or delivery method information indicating a delivery method of the item.

In this case, the payment method or the delivery method can be changed at a time for a plurality of items simply by editing the contents of the supply method list.

In the electronic commerce system according to the present invention, the storing means may store area information identifying an area where the item is to be provided in association with the correspondence information into the item supply method database, and the extraction means may read the supply method list corresponding to the specific item and also corresponding to the area where the item is to be provided from the item supply method database.

In this case, because a supply method for a certain item in a certain shop is set for each area, the supply method in accordance with the area to which the item is to be provided can be presented in a user terminal.

### Advantageous Effects of Invention

According to the electronic commerce system, the electronic commerce method and the electronic commerce program, an item and its supply method are associated with each other through the supply method list, and it is thereby possible to easily set an appropriate supply method for each item simply by editing the contents of the list.

### BRIEF DESCRIPTION OF DRAWINGS

FIG. 1 is a block diagram showing a functional configuration of an electronic commerce system according to an embodiment.

FIG. 2 is a diagram showing a hardware configuration of the electronic commerce system shown in FIG. 1.

FIG. 3 is a diagram showing an example of structure of payment method information.

FIG. 4 is a diagram showing an example of structure of delivery method information.

FIG. 5 is a diagram showing an example of structure of a payment and delivery list.

FIG. 6 is a diagram showing an example of structure of correspondence information.

FIG. 7 is a diagram showing an example of a payment method setting screen.

FIG. 8 is a diagram showing an example of a delivery method setting screen.

FIG. 9 is a diagram showing an example of a list setting screen.

FIG. 10 is a diagram showing an example of an association screen.

FIG. 11 is a flowchart showing a data maintenance process of the electronic commerce system shown in FIG. 1.

FIG. 12 is a flowchart showing an item information presentation process of the electronic commerce system shown in FIG. 1.

FIG. 13 is a diagram showing a configuration of an electronic commerce program according to an embodiment.

### DESCRIPTION OF EMBODIMENTS

An embodiment of the present invention is described hereinafter in detail with reference to the appended drawings. Note that, in the description of the drawings, the same or equivalent elements are denoted by the same reference symbols, and the redundant explanation thereof is omitted.

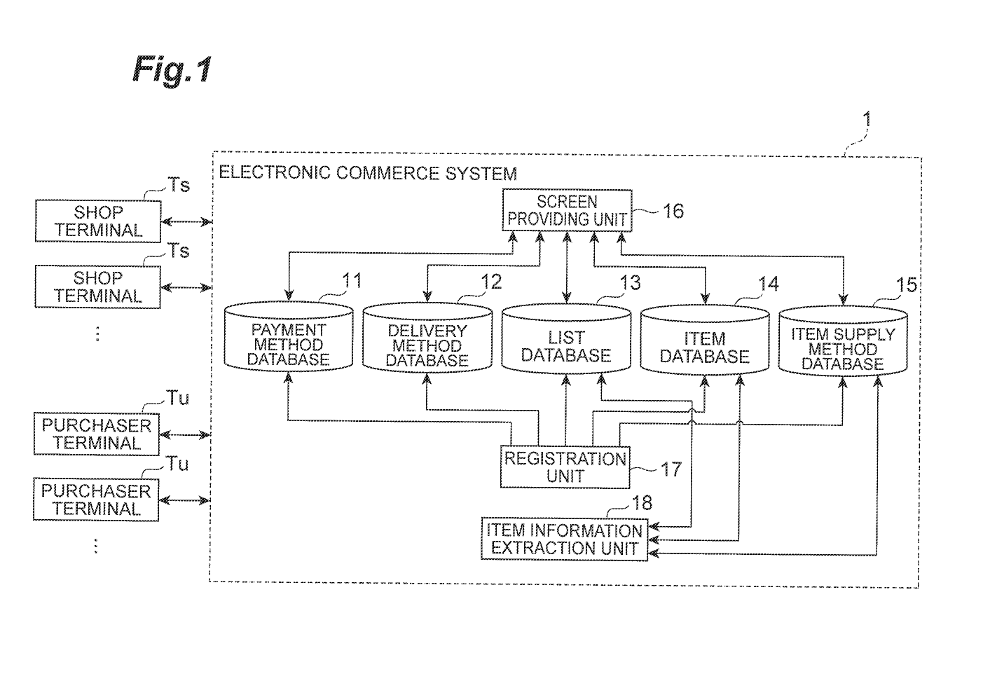

The functions and configuration of an electronic commerce system (which is hereinafter referred to simply as “system”) 1 according to an embodiment are described firstly with reference to FIGS. 1 to 10. The system 1 is a computer system for providing a virtual shopping mall (web site) which contains a plurality of online shops to users who are thinking about purchasing an item. As shown in FIG. 1, the system 1 is connected to terminals (referred to hereinafter as “shop terminals”) Ts of shops which are members of the virtual shopping mall and sell items to general users and terminals (referred to hereinafter as “purchaser terminals”) Tu of general users who are thinking about purchasing items through a given network. Note that the number of shop terminals Ts and purchaser terminals Tu is typically two or more, though the number of those terminals is not particularly limited. Further, a specific configuration of the network is not particularly limited, and a network including the Internet, a private line or the like may be used.

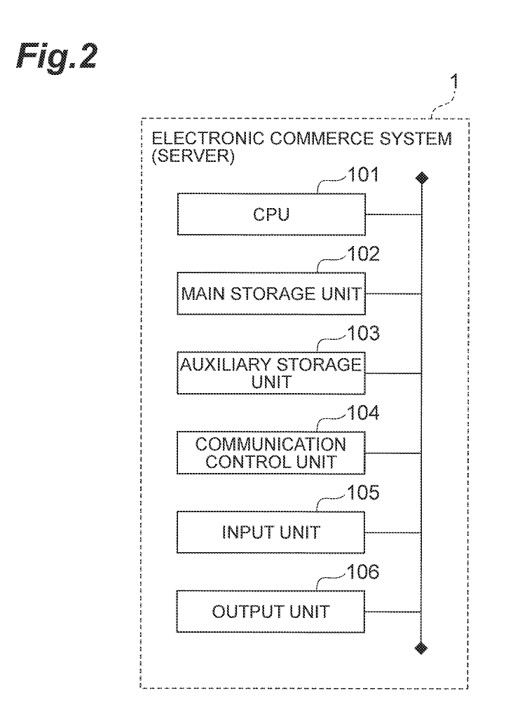

The system 1 may be composed of a single server, or a plurality of servers (distributed system). In any case, the server used in the system 1 has the hardware configuration as shown in FIG. 2. Specifically, the server includes a CPU 101 that executes an operating system, an application program and the like, a main storage unit 102 composed of ROM and RAM, an auxiliary storage unit 103 composed of a hard disk or the like, a communication control unit 104 composed of a network card or the like, an input unit 105 such as a keyboard and a mouse, and an output unit 106 such as a monitor. The functional components of the system 1 described hereinbelow are implemented by loading given software onto the CPU 101 or the main storage unit 102, making the communication control unit 104, the input device 105, the output device 106 and the like operate under control of the CPU 101, and performing reading and writing of data in the main storage unit 102 or the auxiliary storage unit 103.

As shown in FIG. 1, the system 1 includes, as functional components, a payment method database 11, a delivery method database 12, a list database 13, an item database 14, an item supply method database 15, a screen providing unit 16, a registration unit 17, and an item information extraction unit 18.

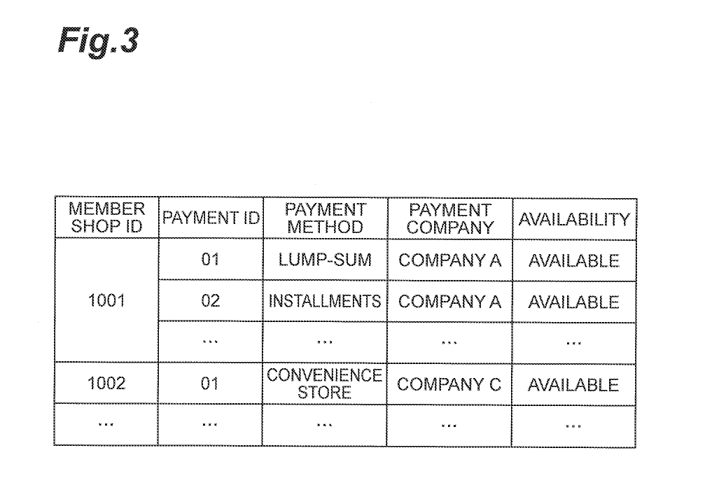

The payment method database 11 is a means of storing a payment method that is set for each shop as payment method information. The payment method information is one type of supply method information indicating an item supply method, and it is associated with a member shop ID that indicates a member shop as shown in FIG. 3. In the example of FIG. 3, the payment method information contains a payment ID indicating a payment method, the name of a payment method (“lump-sum payment”, “installments” etc.), the name of a payment company, and the availability. For example, the payment method database 11 stores the member shop ID “1001” and the payment method information indicating that (payment ID, payment method, payment company, availability) are (“01”, “lump-sum payment”, “company A”, “available”) in association with each other. Note that the structure and contents of the payment method information are not limited to the example of FIG. 3, and various changes may be made. For example, the payment method information may contain information about a payment fee setting method, a discount setting method, an area to apply a payment and the like.

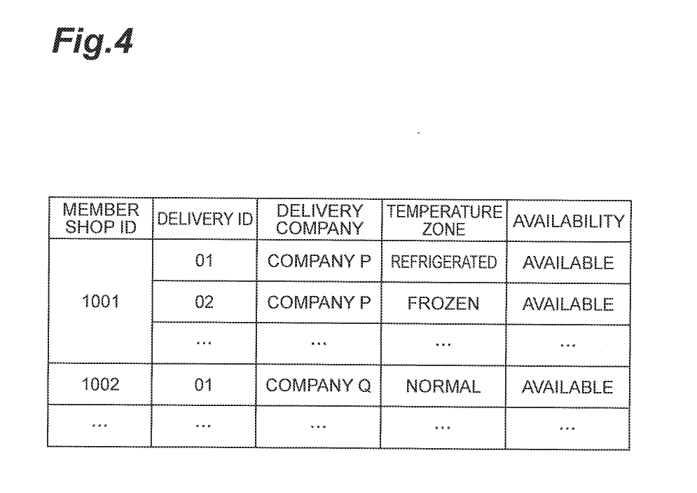

The delivery method database 12 is a means of storing a delivery method that is set for each shop as delivery method information. The delivery method information is also one type of the supply method information, and it is associated with a member shop ID as shown in FIG. 4. In the example of FIG. 4, the delivery method information contains a delivery ID indicating a delivery method, the name of a delivery company, the temperature zone (“normal”, “refrigerated”, “frozen” etc.), and the availability. For example, the delivery method database 12 stores the member shop ID “1001” and the delivery method information indicating that (delivery ID, delivery company, temperature zone, availability) are (“01”, “company P”, “refrigerated”, “available”) in association with each other. Note that the structure and contents of the delivery method information are not limited to the example of FIG. 4, and various changes may be made. For example, the delivery method information may contain information about delivery date options, a delivery charge setting method, an area to apply a delivery and the like.

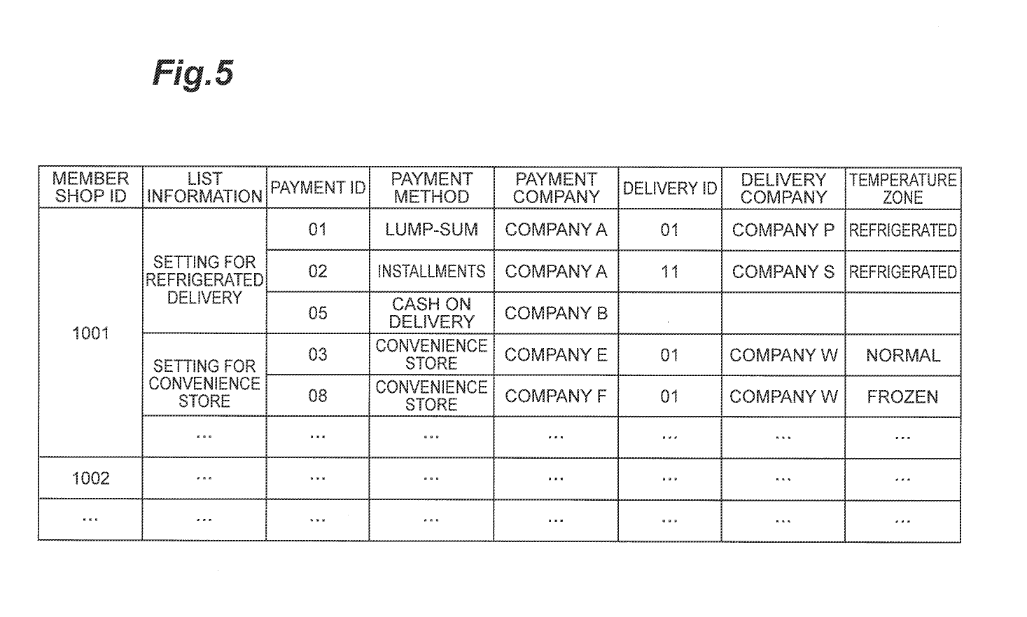

The list database 13 is a means of storing a payment and delivery list (supply method list) that contains one or more payment method information and one or more delivery method information. As shown in FIG. 5, the payment and delivery list contains the member shop ID, list information indicating a list, at least one payment method information, and at least one delivery method information. In the example of FIG. 5, for a member shop with the member shop ID “1001”, two payment and delivery lists “setting for refrigerated delivery” and “setting for convenience store” are shown. The list “setting for refrigerated delivery” contains three payment method information and two delivery method information, and the list “setting for convenience store” contains two payment method information and two delivery method information. In this manner, the number of payment method information and delivery method information contained in one payment and delivery list may be the same or different. The number of supply method information contained in the payment and delivery list may be two or more. Note that the structure or contents of the payment and delivery list are not limited to the example of FIG. 5.

The item database 14 is a means of storing information (item information) related to items available in member shops. Note that the types of items are arbitrary, and the item may be a tangible or intangible product, or a service. The item information contains a member shop ID, an item ID identifying an item, information about item attributes (for example, an item name, manufacturer, price etc.), for example, through the structure of the item information is arbitrary.

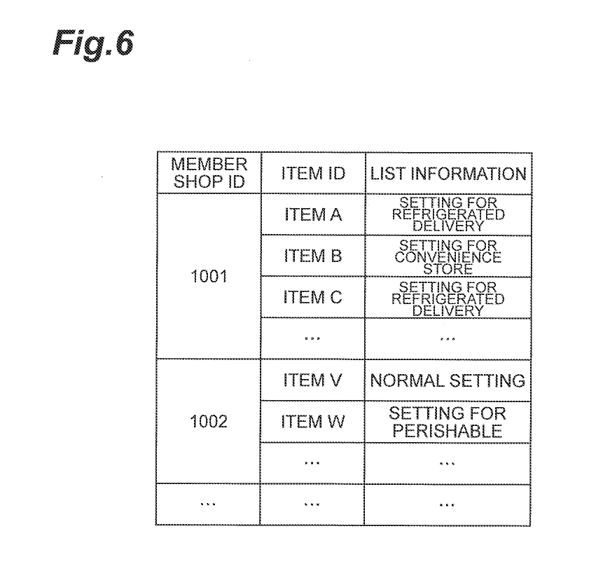

The item supply method database 15 is a means of storing correspondence information indicating the correspondence between the item information and the payment and delivery list in association with member shop information. The item supply method database 15 stores the correspondence information containing an item ID and list information in association with a member shop ID as shown in FIG. 6, for example. Referring to FIG. 6, for a member shop with the member shop ID “1001”, the payment and delivery list “setting for refrigerated delivery” is associated with the items identified by “item A” and “item C”, the payment and delivery list “setting for convenience store” is associated with the item identified by “item B”. In this manner, the correspondence between an item and the payment and delivery list can be found for each shop by reference to the information in the item supply method database 15. Note that the structure or contents of the data stored in the item supply method database 15 are not limited to the example of FIG. 6.

The screen providing unit 16 is a means of providing an input screen for maintaining data about items available in a member shop to the shop terminal Ts. Upon receiving data requesting a specific input screen from the shop terminal Ts, the screen providing unit 16 extracts the member shop ID and the item ID from the data and generates screen data to be provided to the shop terminal Ts. Then, the screen providing unit 16 transmits the generated screen data to the shop terminal Ts. The shop terminal Ts displays an input screen on a monitor on the basis of the transmitted screen data. A user of the shop terminal Ts can thereby make initial registration, change, deletion and the like of various data about items. Note that a markup language such as HTML or XML, for example, may be used to generate an input screen, though a specific screen generation method is arbitrary.

The following four types of screens are particularly described hereinbelow.
Screen for setting the payment method information (payment method setting screen)
Screen for setting the delivery method information (delivery method setting screen)
Screen for setting the payment and delivery list (list setting screen)
Screen for associating the payment and delivery list with an item (association screen)

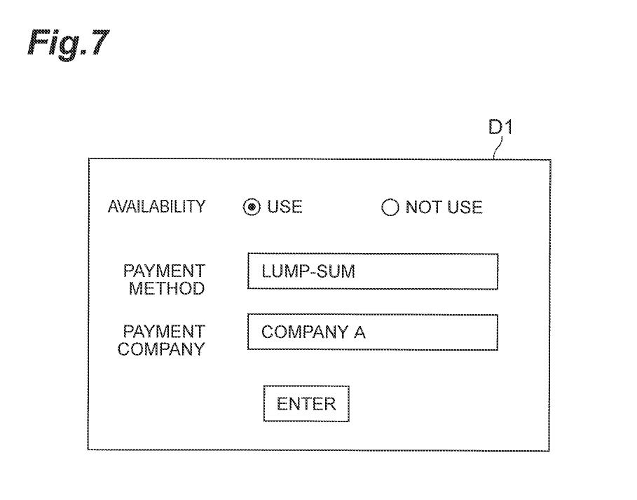

FIG. 7 shows an example of the payment method setting screen as an input screen D1. The input screen D1 corresponds to the data structure of the payment method information shown in FIG. 3, and the availability, payment method and payment company can be input. The Enter button is an interface for transmitting the input payment method information in association with the member shop ID to the system 1.

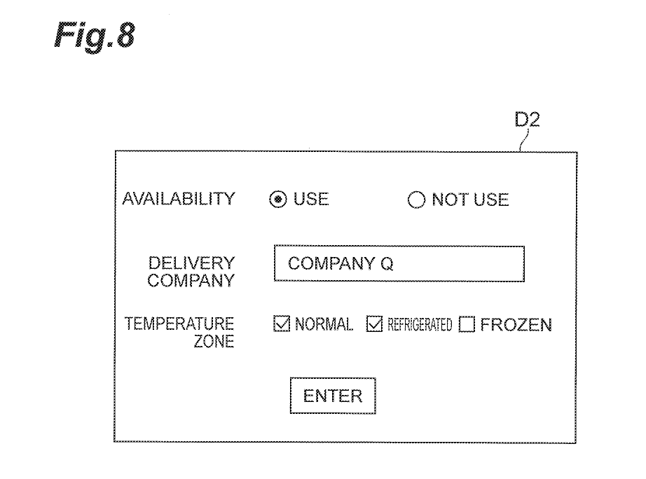

FIG. 8 shows an example of the delivery method setting screen as an input screen D2. The input screen D2 corresponds to the data structure of the delivery method information shown in FIG. 4, and the availability, delivery company and temperature zone can be input. The Enter button is an interface for transmitting the input delivery method information in association with the member shop ID to the system 1. On the input screen D2, the input interface of the temperature zone is a checkbox, and a user of the shop terminal Ts can select a plurality of temperature zones at a time. When two temperature zones are checked as in the example of FIG. 8, two records of the delivery method information are created at a time.

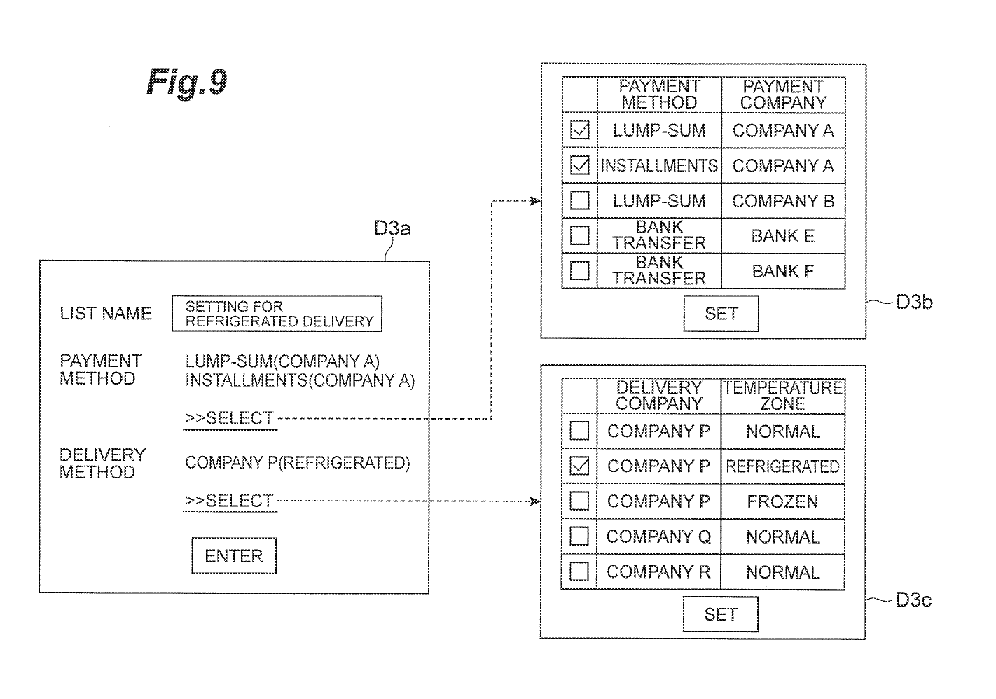

FIG. 9 shows an example of the list setting screen. In the example of FIG. 9, the list setting screen is made up of a main screen D3a, a payment method selection screen D3b, and a delivery method selection screen D3c. On the main screen D3a, a list name can be input, and the input list name is stored as list information into the list database. Further, on the main screen D3a, a list of the payment method information and a list of the payment method information registered at the point of time are displayed. Under each list, a link to display a screen for editing the list (“>>Select” in FIG. 9) is set up. The Enter button is an interface for transmitting the input payment and delivery list in association with the member shop ID to the system 1.

On the payment method selection screen D3b, one or more payment methods corresponding to one certain shop are all displayed, and checkboxes for selecting an arbitrary payment method among them are shown. The Set button is an interface for fixing the payment method and returning to the main screen D3a.

On the delivery method selection screen D3c, one or more delivery methods corresponding to one certain shop are all displayed, and checkboxes for selecting an arbitrary delivery method among them are shown. The Set button is an interface for fixing the delivery method and returning to the main screen D3a.

To create the screens D3a, D3b and D3c, the screen providing unit 16 reads the payment and delivery list, the payment method information and the delivery method information corresponding to the member shop ID transmitted from the shop terminal Ts from the list database 13, the payment method database 11 and the delivery method database 12, respectively. Then, the screen providing unit 16 generates the screen data containing the read information and transmits the data to the shop terminal Ts.

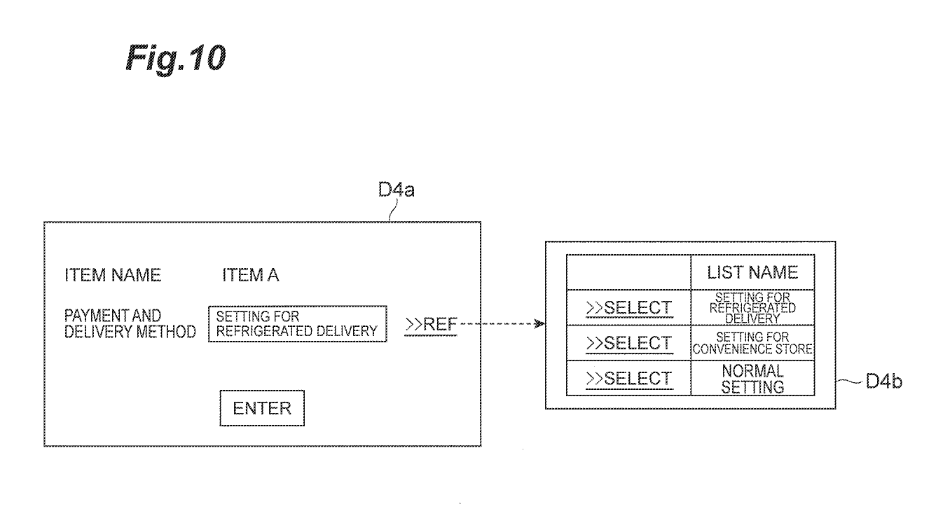

FIG. 10 shows an example of the association screen. In the example of FIG. 10, the association screen is made up of a main screen D4a and a list selection screen D4b. On the main screen D4a, the item information and the payment and delivery list registered at the point of time are displayed, and a link to set the list (“>>Ref” in FIG. 10) is set up. The Enter button is an interface for transmitting the association (correspondence information) between the input item and the list together with the member shop ID to the system 1.

On the list selection screen D4b, one or more payment and delivery lists corresponding to one certain shop are all displayed, and links (“>>Select” in FIG. 10) for selecting one list among them are shown. When a user clicks the link, the display returns to the main screen D4a, and the selected list is displayed in the payment and delivery method field.

To create the screens D4a and D4b, the screen providing unit 16 reads the correspondence information corresponding to the member shop ID and the item ID transmitted from the shop terminal Ts from the item supply method database 15. Further, the screen providing unit 16 reads the payment and delivery list corresponding to the member shop ID from the list database 13. Then, the screen providing unit 16 generates the screen data containing those information and transmits the data to the shop terminal Ts.

Note that the structures of the screens shown in FIGS. 7 to 10 are just one example, and the screen structure may be determined arbitrarily on the basis of the structure of information to be set or displayed, the screen design policy and the like.

The registration unit 17 is a means of storing information that is input through the input screen of the shop terminal Ts in association with the member shop ID into the database.

When the registration is made on the payment method setting screen as shown in FIG. 7, the registration unit 17 receives the payment method information and the member shop ID from the shop terminal Ts and stores those information in association with each other into the payment method database 11. When the received payment method information is new, the registration unit 17 assigns a payment ID to the payment method information.

When the registration is made on the delivery method setting screen as shown in FIG. 8, the registration unit 17 receives the delivery method information and the member shop ID from the shop terminal Ts and stores those information in association with each other into the delivery method database 12. When the received delivery method information is new, the registration unit 17 assigns a delivery ID to the delivery method information.

When the registration is made on the list setting screen as shown in FIG. 9, the registration unit 17 receives the payment and delivery list and the member shop ID from the shop terminal Ts and stores those information in association with each other into the list database 13.

When the registration is made on the association screen as shown in FIG. 10, the registration unit 17 receives the correspondence information (item information and list information) and the member shop ID from the shop terminal Ts and stores those information in association with each other into the item supply method database 15.

The item information extraction unit 18 is a means of, when a specific item of a specific shop is selected in the purchaser terminal Tu, transmitting the payment method information and the delivery method information corresponding to the shop and the item to the purchaser terminal Tu.

When a user who is a potential purchaser accesses the virtual shopping mall through the purchaser terminal Tu and performs the operation to select an item to be purchased, a request for displaying information of the item on the screen of the virtual shopping mall displayed on the purchaser terminal Tu is transmitted from the purchaser terminal Tu to the system 1. The item information extraction unit 18 extracts the item ID and the member shop ID from the request and reads the item information corresponding to those IDs from the item database 14. Further, the item information extraction unit 18 reads the list information corresponding to the item ID and the member shop ID from the item supply method database 15 and then reads one or more payment method information and one or more delivery method information corresponding to the member shop ID and the list information from the list database 13. Then, the item information extraction unit 18 transmits the read item information, payment method information and delivery method information to the purchaser terminal Tu. Those transmitted information are displayed on the purchaser terminal Tu.

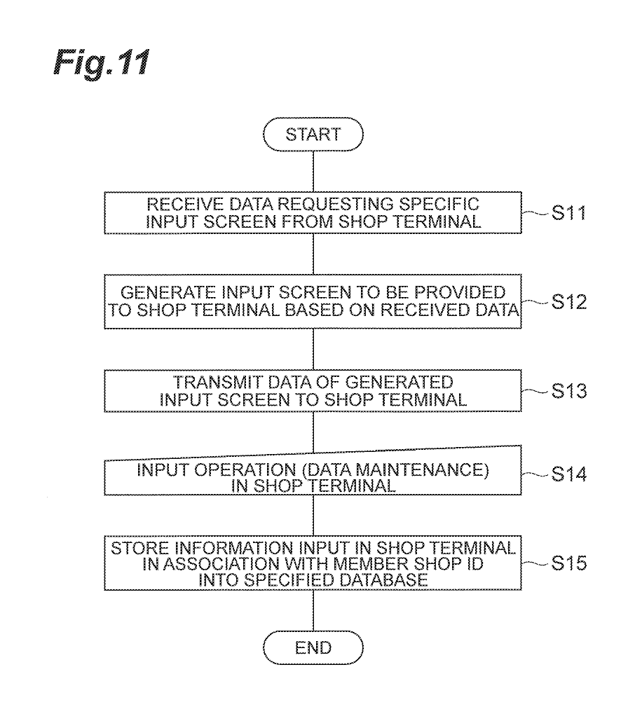

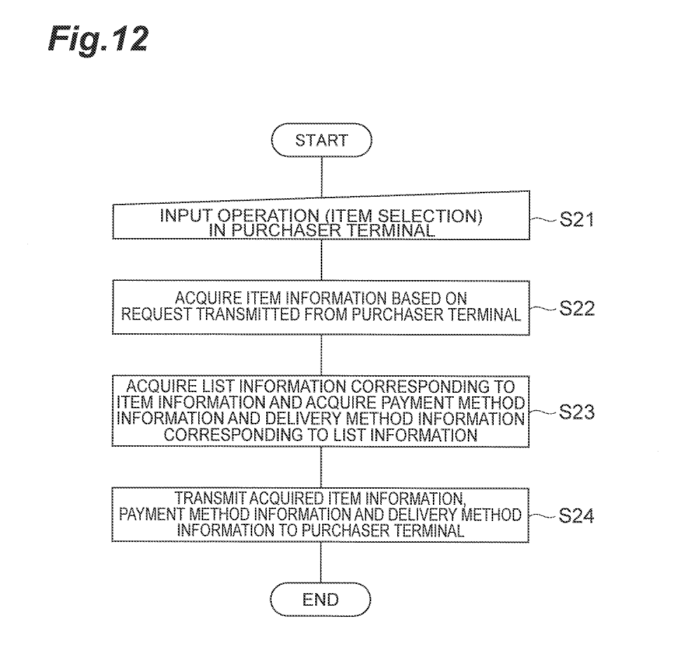

Hereinafter, the operation of the system 1 is described and an electronic commerce method according to the embodiment is also described with reference to FIGS. 11 and 12.

First, the operation related to data maintenance in a member shop is described with reference to FIG. 11. When data requesting a specific input screen is transmitted from the shop terminal Ts, the screen providing unit 16 receives the data (Step S11) and generates an input screen (screen data) to be provided on the basis of the data (Step S12, Screen providing step). The screen data is data of the payment method setting screen, the delivery method setting screen, the list setting screen or the association screen.

At the time of generating a screen, the screen providing unit 16 reads specified information from a specified database according to need and embeds the information into the screen data. For example, at the time of generating the list setting screen, the screen providing unit 16 reads the payment and delivery list, the payment method information and the delivery method information corresponding to a specific member shop ID from the list database 13, the payment method database 11 and the delivery method database 12, respectively. Further, at the time of generating the association screen, the screen providing unit 16 reads the correspondence information corresponding to a specific member shop ID and item ID from the item supply method database 15 and further reads the payment and delivery list corresponding to the member shop ID from the list database 13.

Then, the screen providing unit 16 transmits the generated screen data to the shop terminal Ts (Step S13, Screen providing step). The screen data is displayed on a monitor of the shop terminal Ts and thereby an administrator of the member shop can edit the desired data (Step S14). The data that can be edited in this step is the payment method information, the delivery method information, the payment and delivery list or the correspondence information.

When the Enter button on the input screen is clicked in the shop terminal Ts (Step S14), the data edited on the screen is transmitted together with the member shop ID from the shop terminal Ts to the system 1. The registration unit 17 receives those information and stores the edited data in association with the member shop ID into a specified database (Step S15, Storing step). For example, in the case where the payment and delivery list is transmitted, the registration unit 17 stores the list in association with the member shop ID into the list database 13. Further, in the case where the correspondence information is transmitted, for example, the registration unit 17 stores the correspondence information indicating the correspondence between the item ID and the payment and delivery list in association with the member shop ID into the item supply method database 15. The data maintenance that is done on the member shop side is thereby reflected in the system 1.

Next, the operation when a user of the purchaser terminal Tu who accesses a virtual shopping mall selects a desired item is described with reference to FIG. 12. When a specific item is selected by a specified input operation in the purchaser terminal Tu (Step S21), a request for displaying information of the item on the screen is transmitted from the purchaser terminal Tu to the system 1.

When the system 1 receives the request, the item information extraction unit 18 reads the item information corresponding to the item ID and the member shop ID contained in the request from the item database 14 (Step S22). Further, the item information extraction unit 18 reads the list information corresponding to the item ID and the member shop ID from the item supply method database 15, and then reads the payment method information and the delivery method information corresponding to the read list information from the list database 13 (Step S23, Extraction step). After that, the item information extraction unit 18 transmits the read item information, payment method information and delivery method information to the purchaser terminal Tu (Step S24, Extraction step). The item information containing the payment method and delivery method is thereby displayed on the purchaser terminal Tu, so that a user can check the item information and select the payment method and delivery method.

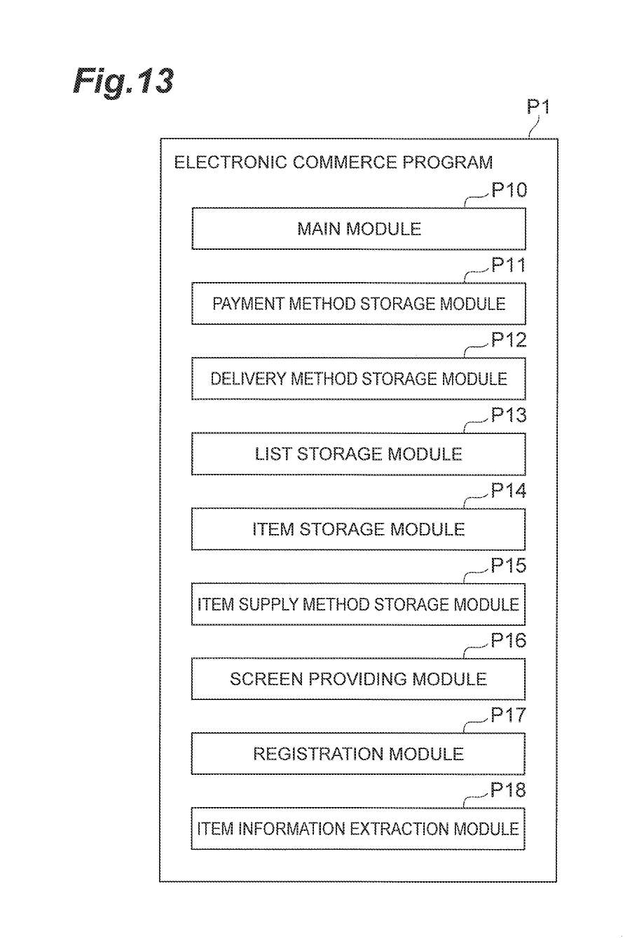

Hereinafter, an electronic commerce program that causes a computer to function as the above-described system 1 is described with reference to FIG. 13.

An electronic commerce program P1 includes a main module P10, a payment method storage module P11, a delivery method storage module P12, a list storage module P13, an item storage module P14, an item supply method storage module P15, a screen providing module P16, a registration module P17, and an item information extraction module P18.

The main module P10 is a part that exercises control over the electronic commerce. The functions implemented by executing the payment method storage module P11, the delivery method storage module P12, the list storage module P13, the item storage module P14, the item supply method storage module P15, the screen providing module P16, the registration module P17, and the item information extraction module P18 are equal to the functions of the payment method database 11, the delivery method database 12, the list database 13, the item database 14, the item supply method database 15, the screen providing unit 16, the registration unit 17, and the item information extraction unit 18, respectively.

The electronic commerce program P1 is provided by a storage medium such as CD-ROM, DVD or ROM or a semiconductor memory, for example. Further, the electronic commerce program P1 may be provided as a computer data signal superimposed onto a carrier wave through a network.

As described above, according to this embodiment, because one or more payment methods and delivery methods can be associated in advance with each item, an appropriate supply method in accordance with the characteristics of the item can be presented to a purchaser of the item. Further, because the item and the supply method are associated through the payment and delivery list, the supply method can be changed at a time for a plurality of items simply by editing the contents of the list. It is thereby possible to easily set an appropriate supply method for each item.

For example, assume that the payment and delivery list for frozen food is created, and only the delivery company that offers frozen delivery is contained in the list. At the time of adding a new company N to the delivery group for frozen food at a later date, the company N is simply added to the payment and delivery list, and then the company N is automatically presented to a user as one or more delivery methods for frozen food. Because no effect is caused on the other payment and delivery lists (delivery groups) as a matter of course, the company N is not presented as a delivery method for an item (for example, utensil) to which another payment and delivery list (delivery group) is applied.

Further, according to this embodiment, the payment method information and the delivery method information to be contained in the payment and delivery list can be set, and the setting is stored into the list database 13. Therefore, the setting can be reflected at a time on a plurality of items.

Further, according to this embodiment, because the input screen for maintaining various data is provided to the shop terminal Ts, the payment method and the delivery method of an item can be freely and easily set on the member shop side. From the viewpoint of the member shop, it is convenient in that an item supply method can be set independently without abiding by the rule of the system 1. On the other hand, from the viewpoint of an administrator of the system 1, the administration load is reduced because the setting of an item supply method can be entrusted to member shops.

The embodiment of the present invention is described in detail above. However, the present invention is not restricted to the above-described embodiment. Various changes and modifications may be made to the present invention without departing from the scope of the invention.

The generation of the payment method information, the delivery method information, the payment and delivery list and the correspondence information may be left to member shops entirely from the beginning, or specified default values may be initially prestored in the databases on the electronic commerce system side.

Further, in preparation for the case where there is an item for which the payment and delivery list is not set, a default payment and delivery list may be set in each shop. For example, a record to correspond to the default payment and delivery list when there is an item for which an item ID is not set in the item supply method database 15 may be prepared for each shop. In this case, the default payment and delivery list for each shop is stored in the list database 13. The default payment and delivery list in the list database 13 and the item supply method database 15 may be prestored in the databases on the electronic commerce system side, for example.

The structure of the databases in the electronic commerce system is not limited to those shown in the above embodiment. For example, the item database 14 and the item supply method database 15 may be integrated into one database. Alternatively, the payment method database 11, the delivery method database 12 and the list database 13 may be integrated into one database, and the item database 14 and the item supply method database 15 may be integrated into one database, for example. Alternatively, two or more databases of the payment method database 11, the delivery method database 12, the list database 13, the item database 14 and the item supply method database 15 may be integrated into one database in an arbitrary combination, for example.

Although the screen providing unit 16 provides four types of screens in the above embodiment, the variety of screens to be provided is not particularly limited. For example, the screen providing means may provide the list setting screen and the association screen only. Further, the structure of screens provided by the screen providing unit 16 is not limited to those shown in the above embodiment, and a field to input arbitrary text information may be included so as to allow a user of the shop terminal Ts to input comments on each screen, for example.

Although the screen providing unit 16 provides a specified input screen to the shop terminal Ts in the above embodiment, a terminal to which the input screen is to be provided is not limited thereto. For example, the screen providing means may provide various input screens to a terminal used by an administrator of the electronic commerce system.

Although the payment method information and the delivery method information are shown as the supply method information in the above embodiment, the structure of the supply method information is not limited thereto. For example, either one of the payment method information or the delivery method information may be treated as the supply method information, or anther type of information may be treated as the supply method information.

In consideration that a payment method and a delivery method often differ from area to area, an area ID that identifies an area to which an item is to be provided (ship-to area) or an area from which an item is to be provided (ship-from area) may be added as an item to identify the payment and delivery list or the correspondence information. Specifically, an area ID may be added as a search key of the list database 13 or the item supply method database 15. Consequently, a supply method for a certain item in a certain shop is set for each area, and therefore the supply method in accordance with the area to which the item is to be provided can be presented to a user of a purchaser terminal. Further, although the system 1 of the above embodiment is a computer system for providing a virtual shopping mall (web site) which contains a plurality of online shops to users who are thinking about purchasing an item, it may be a computer system for providing a virtual shopping mall (web site) which contains a single online shop to users who are thinking about purchasing an item, for example. In this case, when storing the correspondence information indicating the correspondence between the item ID and the payment and delivery list into the item supply method database 15, the registration unit 17 does not necessarily associate the correspondence information with the member shop ID.

### REFERENCE SIGNS LIST

1 . . . electronic commerce system, 11 . . . payment method database (supply method database), 12 . . . delivery method database (supply method database), 13 . . . list database, 14 . . . item database, 15 . . . item supply method database, 16 . . . screen providing unit (screen providing means), 17 . . . registration unit (storing means), 18 . . . item information extraction unit (extraction means), Ts . . . shop terminal (specified terminal), Tu . . . purchaser terminal, P1 . . . electronic commerce program, P10 . . . main module, P11 . . . payment method storage module, P12 . . . delivery method storage module, P13 . . . list storage module, P14 . . . item storage module, P15 . . . item supply method storage module, P16 . . . screen providing module, P17 . . . registration module, P18 . . . item information extraction module

1-7. (canceled)

8. An electronic commerce system comprising:
a list database for storing a supply method list containing one or more supply method information indicating a supply method of an item available in a virtual shop;
a screen providing unit for providing an input screen to associate item information identifying the item and the supply method list read from the list database to a shop terminal of the virtual shop;
a storing unit for storing corresponding information indicating a correspondence between the item information and the supply method list input through the input screen in the shop terminal into an item supply method database; and
an extraction unit for, when a specific item of the virtual shop is selected in a user terminal accessing the virtual shop, reading the supply method list corresponding to the item from the item supply method database and transmitting the supply method information contained in the supply method list to the user terminal.

9. The electronic commerce system according to claim 8, wherein
the virtual shop is a member shop being a member of a virtual shopping mall containing a plurality of virtual shops,
the storing unit stores the corresponding information in association with member shop information identifying the member shop into the item supply method database, and
when the specific item is selected in the user terminal accessing the virtual shop, the extraction unit reads the supply method list corresponding to the virtual shop and also corresponding to the specific item from the item supply method database.

10. The electronic commerce system according to claim 8, further comprising:
a supply method database that stores the supply method information, wherein
the screen providing unit further provides a list setting screen to create the supply method list containing one or more supply method information read from the supply method database to the shop terminal, and
the storing unit further stores the supply method list input through the list setting screen in association with the virtual shop into the list database.

11. The electronic commerce system according to claim 10, wherein
the list setting screen includes a region to display a set of the supply method information corresponding to the virtual shop and an input interface to select one or a plurality of supply method information from the set.

12. The electronic commerce system according to claim 10, wherein
the screen providing unit further provides a supply method setting screen to create the supply method information to the shop terminal, and
the storing unit further stores the supply method information input through the supply method setting screen in association with the virtual shop into the supply method database.

13. The electronic commerce system according to claim 8, wherein
the input screen includes a region to display a set of the supply method lists corresponding to the virtual shop and an input interface to select one supply method list from the set.

14. The electronic commerce system according to claim 8, wherein
the supply method information contains payment method information indicating a payment method of the item or delivery method information indicating a delivery method of the item.

15. The electronic commerce system according to claim 11, wherein the supply method information contains payment method information indicating a payment method of the item and delivery method information indicating a delivery method of the item, and
the list setting screen includes a region to display a set of the payment method information corresponding to the virtual shop as a first set, an input interface to select one or a plurality of payment method information from the first set, a region to display a set of the delivery method information corresponding to the virtual shop as a second set, an input interface to select one or a plurality of delivery method information from the second set.

16. The electronic commerce system according to claim 8, wherein
the storing unit stores area information identifying an area where the item is to be provided in association with the corresponding information into the item supply method database, and
the extraction unit reads the supply method list corresponding to the specific item and also corresponding to the area where the item is to be provided from the item supply method database.

17. An electronic commerce method executed by an electronic commerce system, the method comprising:
a screen providing step of providing an input screen to associate item information identifying an item available in a virtual shop and a supply method list containing one or more supply method information indicating a supply method of the item to a shop terminal of the virtual shop;
a storing step of storing corresponding information indicating a correspondence between the item information and the supply method list input through the input screen in the shop terminal into an item supply method database; and
an extraction step of, when a specific item of the virtual shop is selected in a user terminal accessing the virtual shop, reading the supply method list corresponding to the item from the item supply method database and transmitting the supply method information contained in the supply method list to the user terminal.

18. A non-transitory computer-readable recording medium having an electronic commerce program recorded thereon, the program causing a computer to implement:
a function of a list database that stores a supply method list containing one or more supply method information indicating a supply method of an item available in a virtual shop;
a screen providing function that provides an input screen to associate item information identifying the item and the supply method list read from the list database to a shop terminal of the virtual shop;
a storing function that stores corresponding information indicating a correspondence between the item information and the supply method list input through the input screen in the shop terminal into an item supply method database; and
an extraction function that, when a specific item of the virtual shop is selected in a user terminal accessing the virtual shop, reads the supply method list corresponding to the item from the item supply method database and transmits the supply method information contained in the supply method list to the user terminal.
